(19) United States
(12) Patent Application Publication
(10) Pub. No.: US 2003/0070072 A1
(43) Pub. Date: Apr. 10, 2003

(54) System and method of identity and signature and document authentication using a video conference

(76) Inventor: Nick Nassiri, Los Angeles, CA (US)

Correspondence Address: Nicholas N. Nassiri, 11222 S. La Cienega Blvd, #650, Inglewood, CA, 90304, US

(21) Appl. No.: 09/973,273

(22) Filed: Oct. 9, 2001

(51) Int. Cl. H04L 9/00

(52) U.S. Cl. 713/168; 713/186

(57) ABSTRACT

The present invention utilizes real time, live stream videoconferencing as a means to conduct various types of transactions whereby the identity of the person or the signature of the person or an electronic document must be authenticated, and whereby the parties are geographically remote. To this end, the inventive device includes a video conference or communication system, simultaneous audio and video exchange, an electronic signature capture device, a digital certificate, an electronic notary device, biometric data input; an electronic document repository, encryption technology, and a central process service center.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

1. Field of the Invention

The present invention relates generally to video conferencing and video communications and applications based on the technology thereof and more specifically it relates to an electronic method of identity and signature and document authentication via a “real time” live video conference exchange.

2. Description of the Prior Art

It can be appreciated that methods of video conferencing have been in use for years. Typically, there exits a range of video conference systems or video communication systems that utilize a variety of structures, such as telephone, personal computers and mounted cameras to relay live stream video, and a variety of methods to facilitate the live stream conference. The prior art discloses U.S. Pat. Nos. 5,991,276 issued to Yamamoto; 6,124,882 issued to Voois et al; 6,121,998 issued to Voois et al; 6,128,033 issued to Friedel et al; and 6,037,970 issued to Kondo.

The Yamamoto patent depicts a multipoint videoconference system which delivers video and voice information along with various types of material data to realize a more realistic teleconferencing environment. The system comprises a plurality of videoconference terminals, a videoconference server, and a videoconference administration server. The videoconference administration server controls network connections between the videoconference server and the videoconference terminals. The Yamamoto patent does not depict a method and system of identity and signature and document authentication via a “real time” live stream video conference format.

The Vois U.S. Pat. No. 6,124,882 depicts a videophone device that utilizes a programmable processor circuit capable of communicating over a conventional communications channel, such as a POTS line, and of generating video data for display on a television set. The device includes a video source, an interface circuit, including a modem transmitting and receiving video and audio data over the channel; a circuit for storing a program to control the videophone apparatus; and a display driver circuit for generating video data to the display. The Vois U.S. Pat. No. 6,124,882 does not depict a method and system of identity and signature and document authentication via a “real time” live stream video conference format.

The Vois U.S. Pat. No. 6,121,998 depicts a programmable video/general-purpose processor capable of readily updating program-related data. The processor includes a first circuit section used to process data for videoconferencing and to detect codes data used for revising software-relate data provided from a remote location, and a second circuit section used for executing the executable program data stored in the second memory circuit. A volatile memory circuit is coupled to and accessed by the programmable video/general-purpose processor, and is used for storing the revision data until it is validated. The non-volatile memory circuit is then used by the processor in a subsequent video-related application, such as a videoconferencing application or a web browser application. The Vois patent does not depict a method and system of identity and signature and document authentication via a “real time” live stream video conference format.

The Friedel patent depicts an audiovisual communications terminal apparatus that is adapted for interconnection to at least one other audiovisual communications terminal apparatus by a communications medium to form an audiovisual teleconferencing network. The audiovisual communications terminal apparatus includes an interface device, producing and transmitting means, and receiving and broadcasting means. The interface device operates to condition input audiovisual signals received from the other audiovisual communications terminal apparatus and to condition output audiovisual signals for processing by the other audiovisual communication terminal apparatus. The receiving an broadcasting means receive the input audiovisual signals from the interface device and broadcast the received input audiovisual signals thereby creating an audiovisual teleconference between two users so that the users can both see and hear each other. The Friedel patent does not depict a method and system of identity and signature an document authentication via a “real time” video conference format.

The Kondo patent depicts a videoconference system that conducts a videoconference among a plurality of communication centers which are connected by a communication line. Each communication center includes: display devices for displaying images from the other communication centers participating in the videoconference; speaker devices for outputting voices from the other communication centers participating in the videoconference; camera devices disposed at positions corresponding to the display devices, for imaging participants in the videoconference; microphone devices disposed at positions corresponding to the display devices, for capturing voices from the participants; and a transmitter/receiver transmitting output signals from the camera devices and output signals from the microphone devices to the other communication centers, and receiving output signals from the camera devices and output signals from the microphone devices of the other communication centers, the transmitter/receiver for supplying the output signals from the camera devices and the output signals from the microphone devices of the other communication centers to the display devices and the speaker devices corresponding to the camera devices and the microphone devices. The Kondo patent does not depict a method and system of identity and signature and document authentication via a “real time” live stream video conference format.

The above methods have been widely used in the commercial marketplace in various business practices. For example, found in the marketplace are businesses that utilize live stream video conferencing to facilitate certain communication-based transactions between parties that are geographically remote. The research discloses practices that utilize video conferencing to facilitate transactions such as “remote arraignment” whereby live stream video connects judicial agencies (courts) to penal institutions (where the prisoner resides), thereby enabling the parties to conduct criminal arraignments from remote locations.

Likewise, the research discloses practices that utilize video conferencing to facilitate transactions such as “remote education” whereby educational facilities (the physical classroom) broadcast their lectures to remote locations (one's television set or desktop computer) via live stream video.

The prior art and prevailing business practices clearly illustrate the usefulness and many benefits of systems an methods of videoconference. Great amounts of time and money are saved by uniting geographically remote individuals. Businesses, governmental agencies, consumers, students, an the like benefit from being able to bridge the distance between geographically remote parties. While the prior art discloses very useful means and benefits, existing methods, while joining the remote parties during the live videoconference, fail to facilitate particular transactions during the videoconference: signature authentication, identity authentication or document creation an authentication.

The method of the present invention functions to facilitate any of the foregoing requests singularly, or all of the requests simultaneously. That is: the present invention ma capture a signature, a photograph, biometric data or other forms of electronic data and create an authenticated electronic document using said data input. To put into context: parties that are not familiar with one another may have a need to authenticate the identity of the remote party with whom they videoconference with. For example, two geographically dispersed parties wish to execute a single document to conclude a transaction: such as the sale and subsequent purchase of property. The commercial transaction of the transfer of the real estate property is dependent on verifying the identity of a party to the videoconference, and obtaining the respective signatures of the parties. Methods of signature/identity authentication may include, but are not limited to, electronic signature capture, biometric data capture, photograph capture, or electronic data capture during a live videoconference exchange. The commercial real estate transaction involves the geographically remote parties each individually, nonetheless simultaneously, signing a single electronic document necessary to conclude the transaction, such as a promissory note. Upon the respective electronic data input from the geographically remote parties, such respective electronic data input from each party is verified, and fused in a single, authenticated electronic document.

The prior art fails to disclose any videoconference method whereby signature authentication or identity authentication may be conducted during the videoconference. The prior art fails to disclose any videoconference method whereby electronic data may be captured and input during the video conference. The prior art fails to disclose an videoconference method whereby the respective electronic data input from any party is verified, and fused in a single, authenticated electronic document.

The main problem with conventional real time video conferencing methods is that none of the existing systems or applications incorporate a system, method or process of electronic identity authentication of the geographically remote individuals to the videoconference.

Another main problem with conventional real time video conferencing methods is that none of the existing systems or applications incorporate a system, method or process of electronic signature authentication of the geographically remote individuals to the videoconference.

Another problem with conventional real time video conferencing methods is that none of the existing systems or applications incorporate a system, method or process of electronic document authentication as part of the transaction by the geographically remote individuals to the videoconference.

Another problem with conventional real time video conferencing methods is that none of the existing systems or applications incorporate a system, method or process of electronic authentication of one's identity, signature and the documents simultaneously of the geographically remote individuals to the videoconference.

Another problem with conventional real time video conferencing methods is that none of the existing systems or applications incorporate a system, method or process of electronic authentication of one's identity, signature or documents utilizing biometric data that is conveyed during the video conference.

While the prior art devices and methods may be suitable for the particular purpose to which they address, they are not suitable for real time, live stream electronic authentication of an identity, a signature, or real time live stream electronic document creation and authentication; whether the said identity, signature, or electronic document is authenticated individually or in conjunction with at least one other verification request.

In these respects, the method of electronic identity and signature and document authentication via a real time, live stream videoconference exchange, according to the present invention, substantially departs from the conventional concepts and designs of the prior art, and in so doing provides an apparatus primarily developed for the purpose of an electronic method of identity and signature and document creation and authentication via a real time, live video conference exchange.

### SUMMARY OF THE INVENTION

The general purpose of the present invention, which will be described subsequently in greater detail, is to provide a new method of real time video conference for electronic identity and signature authentication, and for electronic document creation and authentication, that has the many advantages mentioned heretofore and many novel features that result in a new videoconference method which is not anticipated, rendered obvious, suggested, or even implied by any of the prior art video conferencing, either alone or in any combination thereof.

The present invention incorporates a variety of applications and technology that in conjunction can be used to authenticate a personal identity, a signature, or an electronic document, either singularly or simultaneously, during a real time, live stream videoconference. The nature of the transaction is dependent on the needs of the parties to the videoconference. For example, the parties may need identity authentication, or signature authentication, or electronic document creation and authentication, or a combination of all three.

Likewise, the form and type of authentication will vary depending on the needs or requests of the parties. The present invention is capable of a broad base of applications that result in authentication. The method of the present invention utilizes signature data, biometric data, photographs, electronic data input and electronic notarization. Any particular form of authentication may be used singularly or in conjunction with another form of authentication. The purpose of the electronic data capture is to create an authenticated document, such as an executed contract, a passport or drivers license, and the like. The present invention is capable of authenticating any type of document and the foregoing examples are not regarded as limiting. Likewise, it should be understood that the foregoing examples of authentication are all conducted between geographically remote parties during a real time, live stream videoconference.

By way of example, a standard real estate transaction is detailed. Such a transaction typically requires that geographically remote parties physically meet to confirm the identity of one another or that they travel to a notary public to have their identities authenticated. Such a process is time consuming, expensive and inconvenient. Using the present invention, a transfer of title to property would unite the buyer in New Jersey, the seller in California, and the e the notary public in New York in a three way real time, live stream video conference. The geographically remote parties are each able to view one another via a video and audio stream. The parties may each input electronic data, in this instance, a signature, into a single electronic document using the means of the present invention. Upon input of the respective electronic data from the dispersed parties, the present invention serves to manage the electronic data input and generate the desired electronic document. By way of the foregoing example, the result would be a single, authenticated electronic document that is executed by the dispersed parties. A time and date stamp is affixed to the electronic document so that no changes may be made to the encrypted document. The single, finalized notarized electronic document is then issued to the authorized receiving party, such as the registrars office.

In another embodiment, the present inventive method enjoins a customer with a remote governmental agency in a real time, live stream videoconference. In this embodiment, the present invention inputs electronic data from the customer for the purpose of creating an authenticated government issued document, such as a drivers license or a passport. Per the foregoing example, the electronic data input may comprise various forms, including, but not limited to, an electronic signature, a photographic image, biometric data, such as a thumbprint, or electronic data in the form of a code or a password. Using the inventive device, said governmental agency in turn verifies the electronic data input as being authentic. Upon authentication of the input information, an electronic document is created that encapsulates the input electronic data with the document requested, such as a passport or social security card.

In another embodiment of the present invention, a customer accesses the present invention by way of the world wide web (WWW). In this embodiment, the customer initiates a real time, live stream videoconference with a remote site from a location of the customer's choice, such as the home or the office. Per the foregoing methods, the customer will be prompted to input varied forms of electronic data, including, but not limited to, an electronic signature, a photographic image, biometric data, such as a thumbprint, or electronic data in the form of a code or a password. The remote site verifies the input data and in turn creates an authenticated document that is issued to the authorized party, such as a government agency, a medical practitioner, a lawyer, and the like.

The WWW embodiment is put into context by way of the following example. Assume that a customer requires an authenticated student identification card. The customer need not travel to the university for the creation of such a card but may input the required information from the convenience of home. The customer accesses the present invention on the WWW using a configured graphic user interface (GUI). Utilizing the GUI, the customer may input electronic data using a home personal computer. The customer will be prompted to input varied forms of electronic data, including, but not limited to, an electronic signature, including a graphical hand written signature, a photographic image, biometric data, such as a thumbprint, or electronic data in the form of a code or a password. The electronic data input is verified by the present inventive method and amalgamated into an authenticated student card which is issued to the authorized party, presumably the student in this instance.

In any of the embodiments of the present invention, irrespective of the type of service request, whether it be an executed, notarized electronic document or an authenticated identification card, electronic data input by the parties participating in the videoconference may be input singularly or simultaneously. Likewise, input data may comprise various forms of electronic data in a single session, such as: an electronic document, a digital certificate, an electronic notary seal, biometric data, a password or a code, a photographic image and other such data input. Any data input from any party to the videoconference is transmitted via a real time, live stream during the course of the videoconference. Any data input from any party to the videoconference that is transmitted during the course of the videoconference, may be transmitted either singularly or simultaneously by the parties. The input data is subsequently fused to an electronic document and issued to the authorized party.

The above referenced examples illustrate that the present invention is comprised of various technologies that work in conjunction with one another or individually to comprise the method of electronically authenticating one's identity, a signature or a document in real time, live stream video format. To these ends, the present invention is comprised of the following components:

(i) a multi-point and multi-media video conference system (including fixed and portable structures);

(ii) an electronic signature capture device;

(iii) the means to authenticate the electronic signature input by way of the electronic signature capture device;

(iv) a device to create electronic documents;

(v) the means to authenticate electronic documents;

(vi) an electronic document repository;

(vii) a device to create a digital certificate;

(viii) the means to authenticate a digital certificate;

(ix) a device to create an electronic time and date stamp;

(x) the means to authenticate an electronic time and date stamp;

(xi) a device to create an electronic notary seal (detailed in USPTO patent-pending application, identified as Customer 021907);

(xii) the means to authenticate an electronic notary seal (detailed in USPTO patent-pending application, identified as Customer 021907);

(xiii) a device or devices to capture biometric data, such as a fingerprint, photographic image and the like;

(xiv) the means to authenticate biometric data, such as a fingerprint, photographic image and the like;

(xv) a device to fuse the electronic data input with an electronic document;

(xvi) the means to authenticate an electronic document that has electronic data fused to it; and

(xvii) such other applications and or devices which are necessary to facilitate the function of the aforementioned components whether individually or in conjunction with one another.

The primary object of the present invention is to provide an electronic method of personal identity, signature, and electronic document authentication using a real time, live stream videoconference platform that overcomes the shortcomings of the prior art devices.

Another object of the present invention is to provide a method of identity, signature, and electronic document authentication using a real time, live stream videoconference platform that will facilitate electronic commerce: particularly transactions that involve sensitive data or high value transactions.

Another object of the present invention is to provide a method of identity, signature, and electronic document authentication using a real time, live stream videoconference platform that integrates real time electronic data input to facilitate electronic commerce transactions wherein such transactions require the input of personal data, such as an electronic signature or scanned fingerprint.

Another object of the present invention is to provide a method of identity, signature, and electronic document authentication using a real time, live stream videoconference platform that can electronically notarize electronic documents.

Another object of the present invention is to provide a method of identity, signature, and electronic document authentication using a real time, live stream videoconference platform that authenticates the identity of a party to a transaction via a variety of methods, including, but not limited to, electronically transmitted biometric data, personal identification papers, in digital and hard-copy format, codes, encryption keys, passwords or other preordained formulas.

Another object of the present invention is to provide a method of identity, signature, and electronic document authentication using a real time, live stream videoconference platform that allows a plurality of individuals to each individually, but simultaneously, witness the respective individual input electronic data into an electronic document, such as an electronic signature or an electronic fingerprint.

Another object of the present invention is to provide a method of identity, signature, and electronic document authentication that will allow an individual, via an interface with the present invention, direct communication with government agencies that require authentication of either the individual's identity, signature, or documents prior to issuing a government issued document or benefits.

Another object of the present invention is to provide a method of identity, signature, and electronic document authentication using a real time, live stream videoconference platform that fuses the electronic data input by the parties to the electronic documents created through the method of the present invention.

Another object of the present invention is to provide a method of identity, signature, and electronic document authentication using a real time, live stream videoconference platform that allows an individual, via an interface with the present invention, direct communication with government and other regulatory agencies to create hard copy identity-based cards or documents that are encoded with various electronic and biometric information.

There has thus been outlined, rather broadly, the more important features and objectives of the invention in order that the detailed description thereof may be better understood, and in order that the present contribution to the art may be better appreciated. There are additional features of the invention that will be described hereinafter.

Other objects and advantages of the present invention will become obvious to the reader and it is intended that these objects and advantages are within the scope of the present invention. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 FIG. 1 depicts the general routing process of a request for identity or signature authentication. The distinction between the “public” and “private” domain is whether the request involves a government/regulatory entity. The former designation being deemed a “public” process whereby the signature or identity authentication is for the purpose of authenticating a government or a regulatory based identity document. The latter designation being deemed a “private” process whereby the signature or identity authentication is for the purpose of a commercial transaction.

FIG. 2 FIG. 2 depicts the steps and/or methods utilized to authenticate an identity or signature.

FIG. 3 The present invention processes' are somewhat codependent insofar that the process of either identity and signature verification inherently result in an authenticated document. FIG. 3 depicts the steps and/or methods utilized to create, secure and store an electronic document.

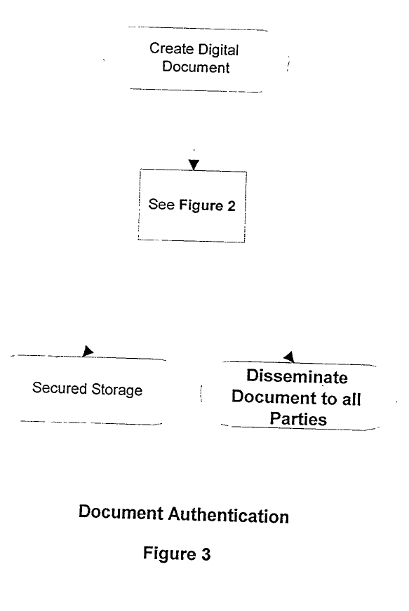

The drawings are intended to provide an over-view of the processes of the present invention. There exist various technological applications by which the objectives of the present invention can be realized. The various means or methods by which authentication shall be established are specifically set forth in the embodiment of the invention as put forth below.

### DESCRIPTION OF THE PREFERRED EMBODIMENT

The present invention recognizes that there is much more to live stream videoconference collaboration than just the video and audio experience. The present invention offers solutions that blend video and audio communication with various forms of electronic data input with a real time, live stream videoconference. Specifically, the present invention is a process, method and system that uses a videoconference system to input and transmit electronic data for the purpose of authenticating an identity, a signature or to create an authenticated electronic document using a real-time, live-stream videoconference medium.

The present invention is useful and efficient because the inventive device is open-ended in application. The present invention can be applied, but is not limited to, the following transactions: any transaction that requires authentication of an identity; any transaction that requires authentication of a signature; or any transaction that requires authentication of an electronic document. The method of the present invention is best suited where the parties to the transaction are geographically remote, and can be utilized for any e-commerce based transaction that requires authentication of either an identity, a signature, or a document; or any transaction where the parties require authentication of either an identity, a signature to issue an identity-based document, such as a passport or a drivers license. The creation and authentication of electronic documents or identity-based documents occurs during the course of the real time, live stream video conference using electronic data input by geographically remote parties to the transaction.

The present invention is premised on the concept of an increasingly borderless world, insofar as technology and the Internet have ever more united remote parties in a host of transactions that once would have necessitated an actual, physical face-to-face meeting. By way of example, one may execute electronic documents online on the Internet using forms of electronic signatures, thereby eliminating the need for the signatories to coordinate a face-to-face meeting. Likewise, one may scan personal biometric data, such as a thumbprint, and submit such data via an electronic upload to a remote database, thereby eliminating the need to manually fingerprint oneself and mail such hard copy information. Remarkably, with ease we now videoconference using desktop computers and telephonic devices that allow geographically remote parties to simultaneously view and hear one another via the Internet.

All of these technologies function to eliminate the need to arrange an actual physical meeting to facilitate a host of transactions. The present invention seeks to coordinate such borderless processes for a method and system of remote party collaboration not rendered by the prior art using a real time, live stream videoconference to enjoin the parties. In the preferred embodiment of the present invention, a customer accesses a remote facility to process a verification request of the customer's identity or the customer's signature, with the purpose of the verification to create an authenticated electronic document.

The remote facility is a physical location with the physical infrastructure and means necessary for the present invention to function, referred to herein as the “Video Verification Service Center” (VVSC). The VVSC is a place of business that allows geographically remote parties to conduct transactions by way of a videoconference that functions to transmit varied electronic data from participants to the videoconference, such as an electronic signature, a photographic image, a fingerprint, or other such electronic data in the course of a videoconference.

Secondly, the VVSC functions to create electronic documents using the input electronic data, such as a graphical, hand written signature, an electronic signature using a digital certificate, a fingerprint or a photograph during the course of a videoconference. The end result being that the participant's biometric information and personal information are fused to an authenticated document. An authenticated document may comprise an executed deed of trust whereby the parties electronic signatures are affixed to the electronic document as a means of authentication, or a drivers license or a passport, whereby the parties electronic signatures and other information such as a thumbprint and photographic image are affixed to the electronic document as a means of authentication.

### APPLICATIONS OF THE PRESENT INVENTION

I. Identity, Signature, and Document Authentication Using a VVSC

To put the system and method of the present invention into context of a specific transaction: two parties that are geographically remote must each individually sign a single document and have each of their respective signatures notarized by a notary public. Each party goes to an independent VVSC that is conveniently located in proximity with their physical location. The VVSC initiates a videoconference with all of the parties to the transaction, including a notary public. The videoconference comprises screens or monitors at each location whereby the parties can input and receive audio, visual and electronic data simultaneously, albeit independently at each location.

Upon initiation of the videoconference, VVSC downloads the electronic document to a central host computer that is to be signed by the parties and that is to be to be notarized by the notary public. The electronic document to be downloaded may be provided in a portable format, such as a diskette or compact disc and is provided by one of the parties to the transaction. Alternatively, the electronic document may be downloaded from a repository of electronic documents maintained by the present invention.

Each VVSC has access to the single host computer where the electronic document has been downloaded. The downloaded electronic document is displayed on a screen or monitor for the respective parties to see, each party viewing the same electronic document. Likewise, the screen or monitor comprises split images that are viewed simultaneously: one of the remote party, one of the electronic document to be signed, one of the electronic data being input and other such multiple imaging as necessary.

Each party executes the electronic document by inputting an electronic signature that is affixed to the electronic document. Electronic signature input may comprise several methods, including, but not limited to, a signature capture device, by biometrics, by a digital certificate, or by a password or code. In the preferred embodiment, each party affixes a graphical, hand written signature using a signature capture device. The present invention comprises the means to affix the graphical, hand written signature to the electronic document. In another embodiment, the electronic signature may be in the form of a digital certificate or other form of source code that is input by the parties to the transaction.

The present invention further comprises the means whereby as each party electronically signs the electronic document, the electronic data being input is displayed on the screen or the monitor. Each party to the videoconference is thereby viewing s single screen with dual images: the other parties, the electronic document, and the electronic signature as it is being captured. In the preferred embodiment the other party thus witnesses the other party signing the electronic document in one image, simultaneously sees the ensuing signature as a separate dual image and the electronic document as a separate dual image.

Upon affixation of each electronic signature to the single electronic document, the screen or monitor will depict the signed electronic document. In the preferred embodiment, the electronic data may be affixed to the electronic document as a visual representation. Alternatively, the electronic data may be affixed to the electronic document in the form of encrypted source code.

Should other electronic data be required, such as a photographic image, a thumbprint, or a code, it will be entered in subsequent fashion and displayed on the screen or monitor. By way of example, in addition to affixing an electronic signature to the electronic document, the parties may request further authentication information such as a drivers license number, or a thumbprint. As such other authentication data is entered, the respective information is displayed on the screen or monitor as a separate image, and is affixed to the electronic document where indicated. In the preferred embodiment, the electronic data may be affixed to the electronic document as a visual representation. Alternatively, the electronic data may be affixed to the electronic document in the form of encrypted source code.

Should notarization be required a notary public authenticates the document by verifying the identity of the signing parties and by affixing an electronic notary seal.

The notary public may be an employee who is physically located at the VVSC or may be a remote party enjoined by the videoconference. Electronic notarization parallels the customary legal form of notarization. The notary public shall require that the signatories provide such authentication information as required by law, typically a government issued photo identification card and a biometric submission, such as a signature or a thumbprint. VVSC employee notary public will have the means to verify hard copy personal identification, such as a drivers license information and to input said information electronically in the form of a source code. Likewise, VVSC employee notary public will have the means to verify the electronic signature of the party and to input said information electronically in the form of a source code. Per the methodology above, the input information is displayed on the screen or monitor as a separate dual image.

Upon input of the personal verification information, VVSC notary public affixes an electronic notary seal to the electronic document. In the preferred embodiment of the present invention, the electronic notary seal is in the form of a graphical representation of the notary public's seal. The graphical representation is affixed to the electronic document as a visual image. Alternatively, the notary seal may be affixed to the document in the form of a source code. Any changes to the electronic document will invalidate the notary public's seal.

Upon affixing all of the required authentication information, including, but not limited to, an electronic signature, a photographic image, biometric information, source code, an electronic notary seal, a time and date stamp is applied and the electronic document is encrypted.

The signed, notarized electronic document is disseminated to the requesting party or parties. If the parties so desire, the VVSC shall archive a copy of the electronic document for future reference.

In another embodiment of the invention, the parties to the transaction may request that a VVSC representative travel to a location of their choice, such as a home or an office. The VVSC representative is equipped with the necessary hardware and the means to facilitate transactions, as depicted above. The VVSC representative initiates a videoconference with the respective parties and with the VVSC itself. The above identified processes are adhered to. The traveling VVSC representative is useful in situations where the parties are unable to travel, such as the infirm or elderly, or in corporate environments that entail several parties to a transaction. Per the method of the preferred embodiment, the traveling VVSC representative may enjoin as many parties to the videoconference as necessary, including a notary public. Alternatively, the traveling VVSC representative may be a notary public.

As the foregoing example clearly illustrates, the present invention has the potential to facilitate transactions where the parties are in different cities, states or even countries. The present invention is open-ended in application and could be used in any e-commerce transaction that requires some form of identity or signature authentication. An individual in New York may purchase a home in California or an automobile overseas. The present invention redresses a significant hurdle to conducting e-commerce, namely, the problem of identity fraud. VVSC authentication not only enables the parties to communicate via a real-time, live stream feed, it allows them to remotely conclude the transaction at hand by accessing a single electronic document simultaneously and inputting their respective personal information.

II. Identity Card Creation Authentication Using a VVSC

In another embodiment of the present invention, the inventive device functions to create personal-identity cards for regulatory agencies, educational institutions, or the private sector. This embodiment functions per the methodology of the first embodiment but with a different objective. As opposed to facilitating e-commerce transactions, the inventive device is used to verify identity and issue authoritative documents. By way of example, a government agency may require authoritative authentication to issue a state sponsored identification card, such as a passport, a social security number or a drivers license.

The customer requiring an identity-based document goes to an independent VVSC that is conveniently located in proximity with their physical location. The VVSC initiates a videoconference with all of the parties to the transaction: the customer and the respective government agency. Per the preferred embodiment, the videoconference comprises screens or monitors at each location whereby the parties can input and receive audio, visual and electronic data simultaneously, albeit independently at each location.

Upon initiation of the videoconference, VVSC downloads the specific electronic document from the electronic document to a central host computer that is to become a particular identity-based document. The downloaded electronic document is displayed on a screen or monitor for the respective parties to see, each party viewing the same electronic document. Likewise, the screen or monitor comprises split images that are viewed simultaneously: one of the remote party, one of the identity-based electronic document to be created, one of the electronic data being input and other such multiple imaging as necessary.

The VVSC shall prompt the customer to provide such personal information as mandated by the requesting agency. Personal information may include, but is not limited to, biometric information, data entry of personal statistics, such as height, weight and birth date, an electronic signature and the like. The input of said personal information may comprise various forms, including, but not limited to, electronic signature input using a signature capture device, by biometrics, by a digital certificate, or by a password or code. In the preferred embodiment, the customer affixes a graphical, hand written signature using a signature capture device to the identity-based electronic document.

Per the method of the preferred embodiment, the present invention comprises the means whereby as the customer electronically signs the electronic document, the electronic data being input is displayed on the screen or the monitor of the requesting agency. The requesting agency to the videoconference is thereby viewing s single screen with dual images: the customer, the identity-based electronic document, and the electronic signature as it is being captured. Upon affixation of each electronic signature to the identity-based electronic document, the screen or monitor will depict the signed identity-based electronic document. In the preferred embodiment, the electronic data may be affixed to the electronic document as a visual representation. Alternatively, the electronic data may be affixed to the electronic document in the form of encrypted source code.

Should other electronic data be required, such as a photographic image, a thumbprint, or a code, it will be entered in subsequent fashion and displayed on the screen or monitor. By way of example, in addition to affixing an electronic signature to the electronic document, the requesting agency may request further authentication information such as a drivers license number, or a thumbprint. As such other authentication data is entered, the respective information is displayed on the screen or monitor as a separate image, and is affixed to the electronic document where indicated. In the preferred embodiment, the electronic data may be affixed to the electronic document as a visual representation. Alternatively, the electronic data may be affixed to the electronic document in the form of encrypted source code.

As the foregoing example clearly illustrates, the present invention has the potential to facilitate transactions where the parties are in different cities, states or even countries. An American traveler who loses a passport in India may find A VVSC, videoconference with the issuing authority, and have a new passport electronically created and issued without the wait, expense or inconvenience of traditional channels.

III. Identity, Signature, and Document Authentication Using a Local Computer System and the World-Wide-Web

In yet another embodiment of the present invention, the parties to the transaction utilize the inventive device independent of the VVSC and independent of a traveling VVSC representative. In this embodiment of the present invention, the parties to the transaction initiate a videoconference via a website that is a function of the VVSC. The web-based VVSC application has a two-fold function: it allows parties to conduct private transactions using a videoconference broadcast via the WWW (webconference), secondly, and it allows registered users to submit electronic data to the VVSC for retrieval and/or dissemination to other parties.

As a priori, to use the present invention from a location independent from a VVSC and independent of a traveling VVSC representative., i.e. the WWW, the customer first must register with the VVSC at its physical location. Registration comprises the VVSC obtaining and verifying personal information from the customer using a variety of data, such as electronic data, government issued personal identity documents, biometric data, such as an electronic signature, a thumbprint and the like, a digital certificate or other such data as may be available. Upon registration, VVSC issues the customer personal identification documents from VVSC, including, but not limited to, a digital certificate, a smart card, a password or a code. VVSC may keep a record of customer's biometric information for future use, should customer elect to do so.

To initiate a transaction independent of the VVSC, a customer wishing signature or identity verification or electronic document creation utilizes the present invention via a local computer system to interface with the VVSC website located on the World Wide Web (WWW). The customer accesses the website via the local computer system and logs in using the password or code as provided by VVSC in the registration process. As per the methodology depicted above, a videoconference is initiated by the VVSC between the parties using a real time, live stream webconference. All parties to the transaction must be registered with the VVSC.

An authentication transaction request using the VVSC website necessitates that the customer use a VVSC graphic user interface (GUI) which runs from the local computer system. The GUI comprises the means for the browser of customer local computer system to display multiple images simultaneously on the monitor of said customer local computer system per the methodology of the preferred embodiment. Said multiple images further comprise: the remote parties to the transaction, the electronic data that is to be input by the parties, and the electronic document that is to be created or authenticated. Not every transaction will comprise every image, the images displayed are dependent on the transaction request.

The webconference method of the inventive device will be most useful in facilitating private e-commerce transactions wherein the parties to the transaction need to ascertain the identity and actual signature of the parties to the transaction. In this aspect, geographically remote individuals may conduct high value or sensitive transactions that necessitate authentication of one's signature to the agreement using the inventive device to webconference with one another, and using the inventive device to exchange electronic data, such as an electronic signature, a photograph, a fingerprint, or an electronic file during the webconference.

Upon initiation of a webconference, the parties to the transaction may opt to upload an electronic document from the local computer system to the VVSC host computer server for electronic data input. Alternatively, the parties may elect to download an electronic document from the electronic document repository maintained by the present invention. The electronic document repository comprises a library of electronic documents designed to facilitate e-commerce, including, but not limited to, deeds of trust, mortgages, promissory notes, affidavits, assignments and so on. Upon either uploading a document, or selecting a document for download, VVSC will structure the transaction request and manage the transaction cycle.

Per the methodology of the preferred embodiment, the electronic document to be executed is depicted along with an electronic image of the electronic signature being affixed to the document as a graphical, hand written representation or as form of source code, and the actual party executing the electronic signature. Said images are displayed on the browser of the local computer system in the manner of a screen or monitor hosted at an independent VVSC.

Upon affixation of each electronic signature to the electronic document, the browser of the local computer system depicts the signed electronic document. In the preferred embodiment, the electronic data may be affixed to the electronic document as a visual representation of a graphical hand-written signature. Alternatively, the electronic data may be affixed to the electronic document in the form of encrypted source code. Should other electronic data be required, such as a photographic image, a thumbprint, or a code, it will be entered in subsequent fashion and displayed on the browser of the local computer system. By way of example, in addition to affixing an electronic signature to the electronic document, the parties may request further authentication information such as a drivers license number, a thumbprint, or a photographic image. As such other authentication data is entered, the respective information is displayed on the browser of the local computer system as a separate image, and is affixed to the electronic document where indicated. In the preferred embodiment, the electronic data may be affixed to the electronic document as a graphic, visual representation. Alternatively, the electronic data may be affixed to the electronic document in the form of encrypted source code.

Per the method of the preferred embodiment, the webconference is capable of providing electronic notarization services to the parties. The notary public ma be an employee who is physically located at the VVSC or may be a remote party enjoined by the webconference. Electronic notarization parallels the customary legal form of notarization. The notary public shall require that the signatories provide such authentication information as required by law, typically a government issued photo identification card and a biometric submission, such as a signature or a thumbprint. VVSC employee notary public will have the means to verify hard copy personal identification, such as a drivers license information and to input said information electronically in the form of a source code. Likewise, VVSC employee notary public will have the means to verify the electronic signature of the party and to input said information electronically in the form of a source code. Per the methodology above, the input information is displayed on the browser of the local computer system as a separate dual image.

Upon input of the personal verification information, VVSC notary public affixes an electronic notary seal to the electronic document. Per the preferred embodiment of the present invention, the electronic notary seal is in the form of a graphical representation of the notary public's seal. The graphical representation is affixed to the electronic document as a visual image. Alternatively, the notary seal may be affixed to the document in the form of a source code. Any changes to the electronic document will invalidate the notary public's seal.

Upon affixing the required authentication information, including, but not limited to, an electronic signature, a photographic image, biometric information, source code, an electronic notary seal, the customer uploads the electronic document to the VVSC web server from the local computer system. The VVSC fuses the respective electronic data input from the remote parties into a single, authenticated electronic document. The single authenticated document is then assigned a time and date stamp and a password. No changes may be made to the electronic document without detection. The password is disseminated to those parties authorized to retrieve a copy of the authenticated document from the VVSC web server. Logging into the server via the local computer system, authorized parties download the single, authenticated electronic document using the password provided from the VVSC.

Turning now descriptively to the drawings, in which similar reference characters denote similar elements throughout the several views, the attached figures illustrate a method of identity and signature and document authentication, the process of which is comprised of the following steps:

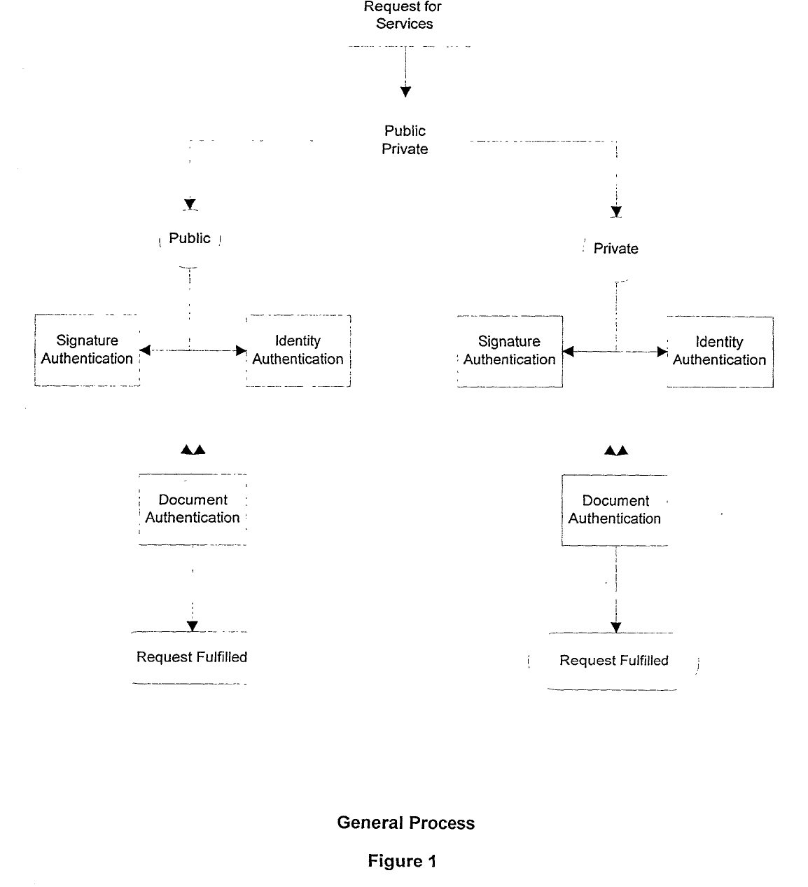

(i) A customer tenders a request to the process center (hereinafter referred to as the Video Verification Service Center) (See FIG. 1—Request for Services) for a real time, live stream video conference service as contemplated herein. The customer's request may be tendered in any viable medium, including but not limited to, electronic mail; the internet; video conference; telephone; or other means of communication to the process unit.

(ii) The Video Verification Service Center (VVSC) is an independent location and includes affiliate locations that offers real-time, live stream signature, identity authentication services and document creation and authentication services. A customer may request a variety of verification requests, including, but not limited to: signature verification to execute contractual agreements, the creation of personal identity documents such as a drivers license or passport; notarization services; and biometric verification requests.

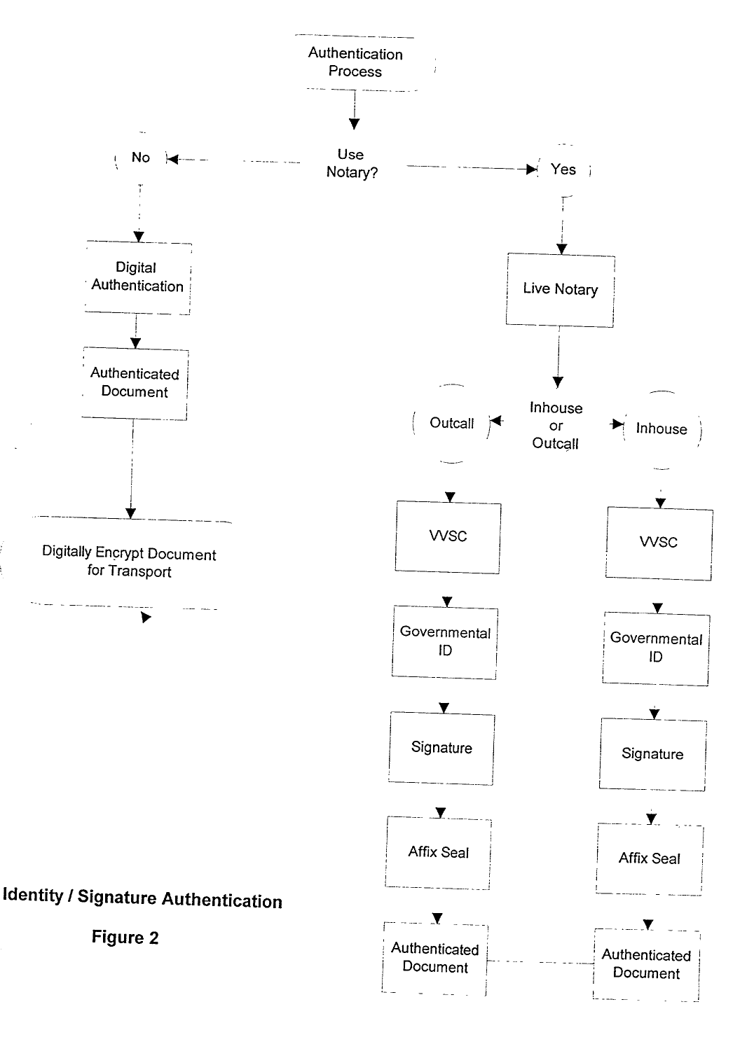

(iii) The VVSC processes the customer's particular request. VVSC will determine the services requested and the parties to the transaction. (See FIG. 2.) As a priori, VVSC determine:

i. Whether the parties to the transaction have the necessary resources to utilize the invention. The distinction is illustrated in the drawings as “in-house” or “outcall”. (Outcall shall presume the customer requires the necessary

resources to facilitate a real time, live stream conference or requires the technical skills of a VVSC representative. In-house presumes that the customer shall come to a VVSC for services);

ii. If not, whether a representative shall bring the necessary resources to utilize the invention to the location of the respective parties, such as the home or the office; and

iii. If not, direct the parties to the nearest VVSC.

(iv) VVSC will establish the time and date and locations for the real time, live stream videoconference between the customer and all pertinent parties.

(v) The time and date will be established by a reservation system which may be manual or electronic or by other means of confirmation. All parties will receive a confirmation prior to the live stream videoconference via electronic mail or other forms of messaging, such as mail or telephone.

(vi) The VVSC will implement, track and manage the services requested by the customer; irrespective of the location of the customer, throughout the real-time live stream video conference.

(vii) The VVSC can provide one or all of the following services:

i. Electronic document creation;

ii. Electronic document authentication through a variety of methods, including but not limited to, electronic notarization utilizing an electronic notary device, digital notarization utilizing a live notary that travels to the Client's location, an electronic signature, biometric data input or a digital certificate;

iii. Creating and authenticating electronic signatures using biometric information or digital certificates, or other electronic data;

iv. Electronic notarization of electronic documents;

v. Electronic document storage and management;

vi. Identity document or identity card creation, such as a drivers license or passport-requires and interface w/regulatory body; or

vii. The capture and encoding of biometric data into card and document format.

(viii) The VVSC will facilitate all transactions and coordinate the involvement of outside parties and agencies if necessary. The following third party entities may be involved:

i. A traveling notary public to authenticate documents;

ii. A traveling VVSC representative that will bring a portable, real time, live stream video conference system to the customer's location, and all necessary appendages thereto for the services contemplated therein; or

iii. Government agencies or other regulatory bodies that utilize the present invention as a method to issue identity based documents or cards.

(ix) The VVSC initiates the transaction, manages the transaction cycle and concludes the transaction. VVSC may archive the electronic document and information created therein by the use of the present invention, at the request of the parties to the transaction.

(x) The present invention has unlimited applications: it serves to facilitate any transaction whereby the capture and authentication of an identity, a signature, or a document is required, albeit the parties to the transaction are geographically dispersed. The invention envisions the following variations of use:

i. The present invention may be used to secure a pledge of oath.

ii. The present invention may be used to create, process and authenticate a government issued document, such as a driver's license or passport.

iii. The present invention may be used to route and facilitate the exchange of expert or professional services world-wide.

iv. The present invention may be used to create documents that require the capture of an image (i.e., one's photograph), a signature, and other personal data, including but not limited to, biometric data.

v. The present invention may be licensed to intranet environments for industry specific applications, such as banking, real estate, legal and governmental operations.

The present invention is an integrated system that utilizes some or all of the components as listed and described below, depending upon the transaction request. The invention operates

on a multi-faceted level as described below and as depicted in the following figures. To these ends, the present invention is comprised of the following components:

(i) a multi-point and multi-media video conference system (including fixed and portable structures);

(ii) an electronic signature capture device;

(iii) the means to authenticate the electronic signature input by way of the electronic signature capture device;

(iv) a device to create electronic documents;

(v) the means to authenticate electronic documents;

(vi) an electronic document repository;

(vii) a device to create a digital certificate;

(viii) the means to authenticate a digital certificate;

(ix) a device to create an electronic time and date stamp;

(x) the means to authenticate an electronic time an date stamp;

(xi) a device to create an electronic notary seal (detailed in USPTO patent-pending application, identified as Customer 021907);

(xii) the means to authenticate an electronic notary seal (detailed in USPTO patent-pending application, identified as Customer 021907);

(xiii) a device or devices to capture biometric data, such as a fingerprint, photographic image and the like;

(xiv) the means to authenticate biometric data, such as a fingerprint, photographic image and the like;

(xv) a device to fuse the electronic data input with an electronic document;

(xvi) the means to authenticate an electronic document that has electronic data fused to it; and

(xvii) such other applications and or devices which are necessary to facilitate the function of the aforementioned components whether individually or in conjunction with one another.

Operation of the Inventive Device

1. Multi-Point, Multi-Media Video Conference System

As a priori, a video-conference or video communicating system will be necessary for the method of the present invention. The video-conference system of the present invention will utilize, including but not limited to, a multi-point, multi-media video-conference or video-communication system, a video-conference server, and a video-conference administration server that will simultaneously deliver video and voice information along with various types of electronic and material data necessary to verify personal identity, signatures and documents. The method of the present invention will be capable of delivering media in various formats, including but not limited to, video clips, audio, text, and graphics.

The video-conference system of the present invention will utilize the various structures and technology of the prior art as referenced above, and other existing video conference systems, including but not limited to, hand-held devices, portable devices, telephonic devices, cellular devices, and satellite devices.

2. Electronic Signature Capture Device

An electronic signature capture device will be necessary for the method of the present invention. The function of the electronic signature capture device will be to capture the electronic signatures of the parties to the transaction and transmit this data as necessary. The electronic signature capture device will be capable of assigning digital code and or graphic images as a means of signature authentication. The graphical representation depicts the actual hand-written signature of the signatory. Additionally, the electronic capture device may be used to input an electronic notary seal.

3. Digital Certificate

A digital certificate will be necessary for the method of the present invention. The function of the digital certificate will be to authenticate either identity or documents. Additionally, the VVSC may issue a digital certificate as a form of personal identity verification upon registration with the VVSC for webconference services.

4. Electronic Notary Device

An electronic notary device will be necessary for the method of the present invention. The function of the electronic notary device will be to provide electronic notarization to electronic documents. The electronic notary stamp is affixed to the electronic document in one of two ways: by manually imprinting the notary seal using the electronic signature capture device pad and the conventional notary stamp, or, alternatively, by utilizing an electronic device that is encrypted with the equivalent of the notary's stamp in the form of source code which is affixed to the electronic document. The present invention will electronically affix the electronic notary seal to verify either a signature that is in a graphical format (using an electronic signature capture device) or an electronic format (using a digital certificate).

5. Biometric Data Capture Device

A system to capture and process bio-metric data, including but not limited to, a signature, a fingerprint, a handprint, a voice print, a photograph, and retina information, will be necessary for the method of the present invention. The function of the biometric input system will be to affix personal characteristics as identified herein in the form of source code to an electronic document or identification card as a means of authentication.

6. Encryption Code

An encryption system will be necessary for the method of the present invention. The function of the encryption system will be to authenticate and secure the electronic document or identification card that is created by the present invention.

7. Electronic Document Repository

An electronic document repository will be necessary for the method of the present invention. The function of the electronic document repository will be to create, transmit, manage and store electronic documents that are created or authenticated by the present invention.

8. Host Computer System

A processing center comprised of a main, regional and local servers will be necessary for the method of the present invention. The processing center will track incoming and outgoing electronic messages; track customer accounts and identities; archive all relevant information for future use and/or reference; and disseminate the foregoing data to regional/local servers and clients as necessary. The main server shall structurally serve to store all of the information generated by the invention and its related processes, systems, and methods. The interconnections between the servers include any and all networks and or systems or applications that facilitate the use of the present invention, and any and all infrastructure necessary to facilitate authentication utilizing the present invention. The processing centers will serve as physical structures that facilitate requests or route them to independent affiliates with the resources to conclude the transaction requested.

All of the components of the present invention serve to work as an integrated whole; however, they are not necessarily utilized all at once. The relationship of the components is dependent on the transaction contemplated. Nonetheless, all of the invention's components will serve to interface with the real time, live stream videoconference transaction. That is, the processes and functions of each component will be integrated into the videoconference process for a relatively simultaneous transaction. Said interface will be in the form of permanent and portable devices that are compatible with the videoconference system being utilized. The invention will also employ any software and hardware applications as necessary to make the invention function as an integrated whole.

The prior art fails to provide an integrated method of simultaneously accomplishing multiple tasks as depicted above. The present invention is able to enjoin and authenticate several transactions in a single process. It is also applicable to any transaction where one's identity, signature or a document requires authentication.

Definitions

Given the possible breadth of the present invention's potential, it is to be understood that the following terms as used anywhere in the application herein shall be construed to have the following meanings:

Transaction: The term “transaction” should be given a broad reading because it encompasses a vast array of possible applications of the present invention. For example, the present invention can authenticate electronic documents that require a notary public to authenticate the signature and the corresponding electronic document; e-commerce documents that require that the identity of a party be verified; signature verification, document authentication; documents that must be signed by the parties simultaneously to take effect, or identification cards and documents that require identity authentication. Likewise, the present invention may be utilized in industry specific environments, such as banking, real estate, legal and governmental operations.

Videoconference: The term “videoconference” or “webconference” and the various verb permeations thereof shall be construed to mean a process that is being conducted real time using live stream data and technology. The present invention may use various videoconference technology and applications thereof, but all are premised on the fact that it is a real time, live stream transaction.

Notary public: The term “notary public” or “notarization” shall be construed to mean authenticating a document using, but not limited to, the following means: a live commissioned notary public; another person certified to authenticate documents; digital forms of notarizing documents such as a digital certificate and the technology identified in United States pending patent application, herein identified as Customer 021907.

Electronic Document: The term “electronic document” shall be construed to mean any data that is constructed and compiled by use of the present invention; including but not limited to, digital or electronic documents in various mediums, whether tangible or not (i.e. source code, compact disc, floppy diskette, etc.); documents encompassing an array of transactions and documents comprised of tracking, managing and storing information created by use of the invention.

Electronic Signature: The term “electronic signature” shall be construed to mean any form of electronic signature, including but not limited to, a graphical, hand written representation using a signature capture device, a digital certificate, a password, or such other electronic data input.

Biometric Data: The term “biometric data” shall be construed to mean any form of biometric information including but not limited to: a fingerprint, a handprint, a voice print, a retina print, an electronic signature, a manual signature, sources of DNA reducible to electronic code and personal information in the form of electronic input: such as height, weight, color, shape and size.

Electronic Data: The term “electronic data” shall be construed to mean any form of electronic data input, including but not limited to: an electronic signature, biometric data, source code, passwords, graphics, audio and other such electronic data.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method and system for performing identity and signature and document authentication using a videoconference; said method and system comprising: a host computer server, a multi-point and multi-media video conference system (including fixed and portable structures), an electronic signature capture device, an electronic document, an electronic document repository, a digital certificate, an electronic notary seal device, a biometric data capture device, and a video verification service center (VVSC); said method and system comprising the steps of:
said VVSC establishing connectivity between geographically remote parties;
said connectivity comprising a videoconference that broadcasts electronic data between said parties using said multi-point and multi-media video conference system;
said parties viewing one another from said multi-point and multi-media video conference system;
said VVSC downloading said electronic document from said host computer server;
said parties viewing the same said electronic document from said multi-point and multi-media video conference system;
said parties inputting an electronic signature using said electronic signature capture device;
said host computer server affixing said electronic signature to said electronic document;
said parties inputting biometric data using said electronic biometric data capture device;
said host computer server affixing said biometric data to said electronic document;
said parties inputting said digital certificate;
said host computer server affixing said digital certificate to said electronic document;
said electronic notary seal device inputting an electronic notary seal;
said host computer server affixing said electronic notary seal to said electronic document;
said host computer server encrypting said electronic document;
said host computer server uploading said electronic document to said host computer server; and
said VVSC disseminating said electronic document to said parties.

2. The system of claim 1 whereby said VVSC comprises a physical stand alone service center that further comprises a stationary infrastructure and a portable infrastructure.

3. The system of claim 1 whereby said parties may be a plurality of parties, each with the ability to participate simultaneously in said videoconference.

4. The system of claim 1 whereby said multi-point and multi-media video conference system further comprises the means to broadcast audio, visual and electronic data during said videoconference to said parties.

5. The method of claim 1 whereby said electronic data further comprises said electronic document, said electronic signature, said biometric data, said digital certificate, and said electronic notary seal.

6. The method of claim 1 whereby said electronic document further comprises digital or electronic documents in various mediums, whether tangible or not (i.e. source code, compact disc, floppy diskette).

7. The method of claim 1 whereby said electronic document may be applicable to an array of transactions, such as banking, real estate, identity based documents and law.

8. The method of claim 1 whereby said electronic signature comprises any form of electronic signature, including a graphical, hand written representation using said signature capture device; source code or a password using said digital certificate, or such other electronic data input.

9. The method of claim 1 whereby said biometric data further comprises a fingerprint, a handprint, a voice print, a retina print, said electronic signature, and sources of personal genetic information reducible to electronic code.

10. The method of claim 1 whereby said host computer server further comprises the means to download said electronic document from a repository and to display said electronic document on a screen or monitor of said multi-point and multi-media video conference system.

11. The method of claim 1 whereby said host computer server further comprises the means whereby said parties input said electronic signature using said electronic signature capture device.

12. The method of claim 1 whereby said host computer server further comprises the means to affix said electronic signature to said electronic document.

13. The method of claim 1 whereby said host computer server further comprises the means whereby said parties input said biometric data using said electronic biometric data capture device.

14. The method of claim 1 whereby said host computer server further comprises the means to affix said biometric data to said electronic document.

15. The method of claim 1 whereby said host computer server further comprises the means whereby said parties input said digital certificate.

16. The method of claim 1 whereby said host computer server further comprises the means to affix said digital certificate to said electronic document.

17. The method of claim 1 whereby said host computer server further comprises the means whereby said electronic notary seal device inputs said electronic notary seal.

18. The system of claim 17 whereby said electronic notary seal may be in the form of a graphical representation or in the form of source code.

19. The method of claim 1 whereby said host computer server further comprises the means to affix said electronic notary seal to said electronic document.

20. The method of claim 1 whereby said host computer server further comprises the means whereby said parties may input said electronic data into said electronic document individually or simultaneously.

21. The method of claim 1 whereby said host computer server further comprises the means whereby said parties may simultaneously view said electronic data input into said electronic document from said screen or monitor of said multi-point and multi-media video conference system.

22. The method of claim 1 whereby said host computer server further comprises the means to encrypt said electronic document.

23. The method of claim 1 whereby said host computer server further comprises the means to upload said electronic document to said host computer server database for future retrieval and storage.

24. A method and system for performing identity and signature and document authentication using a videoconference; said method and system comprising: a host computer server, a multi-point and multi-media video conference system (including fixed and portable structures), an electronic signature capture device, an electronic document, an electronic document repository, a digital certificate, an electronic notary seal device, a biometric data capture device, and a video verification service center (VVSC); said method and system comprising the steps of:
said VVSC establishing connectivity between geographically remote parties;
said connectivity comprising a videoconference that broadcasts electronic data between said parties using said multi-point and multi-media video conference system;
said parties viewing one another from said multi-point and multi-media video conference system;
said VVSC downloading said electronic document from said host computer server;
said parties viewing the same said electronic document from said multi-point and multi-media video conference system;
said parties inputting an electronic signature using said electronic signature capture device;
said host computer server affixing said electronic signature to said electronic document;
said parties inputting biometric data using said electronic biometric data capture device;
said host computer server affixing said biometric data to said electronic document;
said parties inputting said digital certificate;
said host computer server affixing said digital certificate to said electronic document;
said host computer server encrypting said electronic document;
said host computer server uploading said electronic document to said host computer server or to a remote server of said parties;
said host computer server creating an identity-based document with said electronic document; and
said host computer server disseminating said identity-based document to authorized said parties.

25. The method of claim 24 whereby said VVSC further comprises a physical stand alone service center that further comprises a stationary infrastructure and a portable infrastructure.

26. The method of claim 24 system of claim 24 whereby said parties may be a plurality of parties, each with the ability to participate simultaneously in said videoconference; said plurality of parties further comprising at least one governmental or regulatory agency.

27. The system of claim 24 whereby said multi-point and multi-media video conference system further comprises the means to broadcast audio, visual and said electronic data during said videoconference to said parties.

28. The method of claim 24 whereby said electronic data further comprises said electronic document, said electronic signature, said biometric data, said digital certificate, and said electronic notary seal.

29. The method of claim 24 whereby said electronic document further comprises digital or electronic documents in various mediums, whether tangible or not (i.e. source code, compact disc, floppy diskette).

30. The method of claim 24 whereby said host computer server further comprises the means to create said electronic document for the purpose of transactions that involve personal identity authentication, such as a drivers license, a passport, or a social security number.

31. The method of claim 24 whereby said electronic signature comprises any form of electronic signature, including a graphical, hand written representation using said signature capture device; source code or a password using said digital certificate, or such other electronic data input.

32. The method of claim 24 whereby said biometric data further comprises a fingerprint, a handprint, a voice print, a retina print, said electronic signature, and sources of personal genetic information reducible to electronic code.

33. The method of claim 24 whereby said host computer server further comprises the means to download said electronic document from said repository and to display said electronic document on said screen or monitor of said multi-point and multi-media video conference system.

34. The method of claim 24 whereby said host computer server further comprises the means whereby said parties input said electronic signature using said electronic signature capture device.

35. The method of claim 24 whereby said host computer server further comprises the means to affix said electronic signature to said electronic document.

36. The method of claim 24 whereby said host computer server further comprises the means whereby said parties input said biometric data using said electronic biometric data capture device.

37. The method of claim 24 whereby said host computer server further comprises the means to affix said biometric data to said electronic document.

38. The method of claim 24 whereby said host computer server further comprises the means whereby said parties input said digital certificate.

39. The method of claim 24 whereby said host computer server further comprises the means to affix said digital certificate to said electronic document.

40. The method of claim 24 whereby said host computer server further comprises the means whereby said electronic notary seal device inputs said electronic notary seal.

41. The system of claim 40 whereby said electronic notary seal may be in the form of a graphical representation or in the form of source code.

42. The method of claim 24 whereby said host computer server further comprises the means to affix said electronic notary seal to said electronic document.

43. The method of claim 24 whereby said host computer server further comprises the means whereby said parties may input said electronic data into said electronic document individually or simultaneously.

44. The method of claim 24 whereby said host computer server further comprises the means whereby said parties may simultaneously view said electronic data input into said electronic document from said screen or monitor of said multi-point and multi-media video conference system.

45. The method of claim 24 whereby said host computer server further comprises the means to encrypt said electronic document.

46. The method of claim 24 whereby said host computer server further comprises the means to upload said electronic document to said host computer server database for future retrieval and storage.

47. The method of claim 24 whereby said host computer server further comprises the means to create said identity-based document from said electronic document.

48. The system of claim 47 whereby said identity-based document further comprises a variety of forms, whereby said identity-based document comprises a tangible hard copy document, or whereby said identity-based document comprises intangible source code, or whereby said identity-based card comprises a combination of both.

49. The system of claim 48 whereby said identity-based document further comprises a variety of said electronic data, including, but not limited to said biometric data.

50. The method of claim 24 whereby said host computer server disseminates said identity-based document to authorized said parties.

51. A method and system for performing identity and signature and document authentication using a videoconference conducted via the World-Wide-Web (WWW); said method and system comprising: a host computer server, a local computer system, a multi-point and multi-media video conference system (including fixed and portable structures), a website, an electronic signature capture device, an electronic document, an electronic document repository, a digital certificate, an electronic notary seal device, a biometric data capture device, and a video verification service center (VVSC); said method and system comprising the steps of:
said local computer system using Internet connectivity to access said website;
said local computer system establishing connectivity between geographically remote parties via said website;
said connectivity comprising a videoconference that broadcasts electronic data between said parties using said multi-point and multi-media video conference system and said website;
said parties viewing one another from said multi-point and multi-media video conference system;
said local computer system downloading said electronic document from said host computer server;
said parties viewing the same said electronic document from said multi-point and multi-media video conference system;
said parties inputting an electronic signature using said electronic signature capture device;
said host computer server affixing said electronic signature to said electronic document;
said parties inputting biometric data using said electronic biometric data capture device;
said host computer server affixing said biometric data to said electronic document;
said parties inputting said digital certificate;
said host computer server affixing said digital certificate to said electronic document;
said electronic notary seal device inputting an electronic notary seal;
said host computer server affixing said electronic notary seal to said electronic document;
said host computer server encrypting said electronic document;
said host computer server uploading said electronic document to said host computer server; and
said host computer server disseminating said electronic document to said parties.

52. The method of claim 51 whereby said host computer server further comprises the means to operate said website; said website allows said parties to access and use the inventive device and to manage the transactions contemplated therein.

53. The method of claim 51 whereby said parties may be a plurality of parties, each with the ability to participate simultaneously in said videoconference using said local computer system.

54. The system of claim 51 whereby said multi-point and multi-media video conference system is a function of said local computer system.

55. The method of claim 51 whereby said multi-point and multi-media video conference system further comprises the means to broadcast audio, visual and electronic data during said videoconference to said parties.

56. The method of claim 51 whereby said electronic data further comprises said electronic document, said electronic signature, said biometric data, said digital certificate, and said electronic notary seal.

57. The method of claim 51 whereby said electronic document further comprises digital or electronic documents in various mediums, whether tangible or not (i.e. source code, compact disc, floppy diskette).

58. The method of claim 51 whereby said electronic document may be applicable to an array of transactions, such as banking, real estate, identity based documents and law.

59. The method of claim 51 whereby said electronic signature comprises any form of electronic signature, including a graphical, hand written representation using said signature capture device; source code or a password using said digital certificate, or such other electronic data input.

60. The method of claim 51 whereby said biometric data further comprises a fingerprint, a handprint, a voice print, a retina print, said electronic signature, and sources of personal genetic information reducible to electronic code.

61. The method of claim 51 whereby said local computer system further comprises the means to download said electronic document from a repository and to display said electronic document on a screen or monitor of said local computer system.

62. The method of claim 51 whereby said host computer server further comprises the means whereby said parties input said electronic signature using said electronic signature capture device.

63. The method of claim 51 whereby said host computer server further comprises the means to affix said electronic signature to said electronic document.

64. The method of claim 51 whereby said host computer server further comprises the means whereby said parties input said biometric data using said electronic biometric data capture device.

65. The method of claim 51 whereby said host computer server further comprises the means to affix said biometric data to said electronic document.

66. The method of claim 51 whereby said host computer server further comprises the means whereby said parties input said digital certificate.

67. The method of claim 51 whereby said host computer server further comprises the means to affix said digital certificate to said electronic document.

68. The method of claim 51 whereby said host computer server further comprises the means whereby said electronic notary seal device inputs said electronic notary seal.

69. The method of claim 51 whereby said electronic notary seal may be in the form of a graphical representation or in the form of source code.

70. The method of claim 51 whereby said host computer server further comprises the means to affix said electronic notary seal to said electronic document.

71. The method of claim 51 whereby said host computer server further comprises the means whereby said parties may input said electronic data into said electronic document individually or simultaneously.

72. The method of claim 51 whereby said host computer server further comprises the means whereby said parties may simultaneously view said electronic data input into said electronic document from said screen or monitor of said multi-point and multi-media video conference system.

73. The method of claim 51 whereby said host computer server further comprises the means to encrypt said electronic document.

74. The method of claim 51 whereby said host computer server further comprises the means to upload said electronic document to said host computer server database for future retrieval and storage.

75. The method of claim 51 whereby said host computer server further comprises the means to create said identity-based document from said electronic document.

76. The system of claim 75 whereby said identity-based document further comprises a variety of forms, whereby said identity-based document comprises a tangible hard copy document, or whereby said identity-based document comprises intangible source code, or whereby said identity-based card comprises a combination of both.

77. The system of claim 76 whereby said identity-based document further comprises a variety of said electronic data, including, but not limited to said biometric data.
